(19) United States
(12) Patent Application Publication
(10) Pub. No.: US 2006/0259316 A1
(43) Pub. Date: Nov. 16, 2006

(54) Sarbanes-Oxley compliance system

(75) Inventors: Jud Breslin, Mountain Lakes, NJ (US); Norman Myatt, Mountain Lakes, NJ (US)

Correspondence Address: AUFRICHTIG STEIN & AUFRICHTIG, P.C., 300 EAST 42ND STREET, 5TH FLOOR, NEW YORK, NY, 10017, US

(73) Assignee: NPSOX.COM LLC

(21) Appl. No.: 11/412,474

(22) Filed: Apr. 26, 2006

Related U.S. Application Data
(60) Provisional application No. 60/674,844, filed on Apr. 26, 2005.

(51) Int. Cl. G06Q 99/00

(52) U.S. Cl. 705/1

(57) ABSTRACT

A system for bringing and maintaining an entity into compliance with the Sarbanes-Oxley Act including business process templates that can be edited, deleted or added and a central repository of control actions and data that can be utilized by the Sarbanes-Oxley compliance system. Documentation of each of the business process templates and control actions is included. The system builds an internal control framework by marrying the documentation, business processes and control actions together, along with a link to an organizational chart tying a person to the control actions and business processes, as well as the documentation. The system also provides auditing control on an access based and push based model.

This application claims the priority of application Ser. No. 60/674,844 filed on Apr. 26, 2005.

### BACKGROUND OF THE INVENTION

The invention is directed to a system which complies with the accounting and control requirements of the Sarbanes-Oxley Act. The Sarbanes-Oxley Act became law on Jul. 30, 2002. Section 404 of the law compels executives to understand and prioritize infrastructure elements according to their material impact on the company's financial statements. Management must maintain documentation of basic and critical business processes, transaction discipline and related internal controls.

Section 404 drives companies to document and understand the linkages of their infrastructure components and reporting, and to assign responsibility, ownership and accountability. The company must file an internal control report with its annual 10K report including management's responsibilities to establish and maintain internal controls and management's conclusion on effectiveness of these controls.

The SEC requires organizations to establish a sound internal control structure and to manage and monitor that structure proactively.

These complex requirements cover all of the operations and departments within the corporate structure and establishment, management and control of each of the business processes and operational actors in a transparent and hierarchical fashion. In large organizations with significant businesses and numerous departments, each of which is responsible for its own functions and interfacing with other departments and various levels of management, the effort to meet the requirements of the Sarbanes-Oxley Act are onerous, Herculean and expensive to establish and maintain.

In addition to for profit companies not-for-profit companies are now being required to meet the requirements of the Sarbanes-Oxley Act. Not by law, but to attract funding from foundations and other large benefactors, who insist on the rigorousness of internal controls which the requirements of the Sarbanes-Oxley Act create. Many of these companies are far less structured in a management and personnel sense than the publicly traded companies and are thus much less able to muster the resources to set themselves up to comply.

Accordingly, there is a need for a system which will allow an organization to implement the requirements of the Sarbanes-Oxley Act without radically altering its operational systems or allocating huge resources to the effort by utilizing a customizable prepared template of structures and procedures which includes a tightly linked relationship between the Sarbanes-Oxley Act directives, standardized and customized business processes, employee responsibility structures, and control structures and procedures.

### SUMMARY OF THE INVENTION

The invention is directed to a system for bringing and maintaining an entity into compliance with the Sarbanes-Oxley Act requirements. The system includes business process templates that can be edited, deleted or added. It also includes a repository of control actions that can be edited, deleted or added. Documentation of each of the business process templates and control actions is included. The system also builds an internal control framework by marrying the documentation, business processes and control actions together. A further link to an organizational chart ties a person to the control actions and business processes as well as the documentation.

The invention is also directed to a product which includes business process, control action, documentation and organizational information cross linked and proactively to provide appropriate management control of the structure required by the Sarbanes-Oxley Act to allow the CEO and CFO of an organization to be able to sign off on required SEC filings by providing appropriate supervisory notices and the ability to observe required details.

Another goal of the invention is to provide for the control actions to be monitored thru email alerts.

Yet another goal of the invention is to provide the communication of the control actions thru a database.

Still another goal of the invention is to provide a system for tying a person to the organizational chart and to the control actions and the business processes.

A further goal of the invention is to provide a product for Not For Profit companies which includes business process, control action, documentation and organizational information cross linked and proactively to provide appropriate management control of the structure required of publicly traded companies by the Sarbanes-Oxley Act to allow the managing board or trustees of the organization to be able to sign off on the required financial reporting by providing appropriate supervisory notices and the ability to observe required details.

Still other objects and advantages of the invention will, in part, be obvious and apparent from the specification.

The invention accordingly comprises the features of construction, combinations of elements and arrangements of parts and processes which will be exemplified in the constructions and processes as hereinafter set forth, and the scope of the invention will be indicated in the Claims.

### BRIEF DESCRIPTION OF THE DRAWINGS

For a fuller understanding of the invention, reference is made to the following description taken in connection with the accompanying drawings, in which:

FIG. 1 is a diagrammatic view of the internal control environment of the Sarbanes-Oxley compliance system in accordance with a preferred embodiment of the invention;

FIG. 2 is another diagrammatic view of the internal control environment of the Sarbanes-Oxley compliance system in accordance with a preferred embodiment of the invention;

FIG. 3 is a series of four screen shots of the Sarbanes-Oxley compliance system in accordance with a preferred embodiment of the invention;

FIG. 4 is a flow chart diagram of the benefits of the Sarbanes-Oxley compliance system in accordance with a preferred embodiment of the invention;

FIG. 5 is a screen shot of the Sarbanes-Oxley compliance system in accordance with a preferred embodiment of the invention showing an entry screen in the business process management module;

FIG. 6 is another screen shot of the processes for which a fixed asset administrator is responsible;

FIG. 7 is a screen shot identifying the risk categories;

FIG. 8 is a screen shot showing a portion of the employment hierarchy;

FIG. 9 is a screen shot for fixed assets identifying a particular risk;

FIG. 10 is a screen shot of control point associated with a particular risk;

FIG. 11 is a screen shot of three separate screens combined to identify the auditing procedures in the Sarbanes-Oxley compliance system in accordance with a preferred embodiment of the invention;

FIG. 12 is a screen shot of a timeline program in accordance with a preferred embodiment of the invention showing the planning for implementation of the Sarbanes-Oxley compliance system;

FIG. 13 is another screen shot showing a shortened timeline for implementation activities;

FIG. 14 is a screen shot of a development screen showing the finished screen and entry information for a link; and

FIG. 15 is a screen shot similar to FIG. 14 with the entry information for a control point.

### DETAILED DESCRIPTION OF THE PREFERRED EMBODIMENTS

The phrase “like a deer caught in the headlights” is all too familiar to corporate America. Totally unforeseen, the “headlights” can swing around the corner at any moment, creating unwanted corporate confusion and liability. Just think of Pfizer and the light that was aimed at Celebrex not too long ago—the same light that then shone on Merck's Vioxx.

The Sarbanes-Oxley Act (“S.O.A.”), caught many public companies in its headlights. The potential for liability is significant, and the solution appears to be both elusive and expensive. That is because Sarbanes-Oxley is not a one-time process as was Y2K. Sarbanes-Oxley is an on-going requirement that includes these three very distinct phases:

| | | |
|---|---|---|
| Phase 1: | Initiation: | Setting up the initial S.O.A. program |
| | | including the scope, the audit points on locations, |
| | | and the audit procedures to be followed. |
| Phase 2: | Attestation: | Performing the initial audits as |
| | | dictated by the S.O.A. program |
| | | and recording the results. |
| Phase 3: | Monitoring: | On-going auditing with proof of attestation |
| | | and visible alerts generated when failures |
| | | or warning incidences occur. |

It has been projected that medium-sized manufacturing companies will spend an average of $2.5 million on Phases 1 and 2 alone. Few have considered the cost of Phase 3, and yet, because it is an on-going requirement, it will be the costliest of all the phases. To date, there are few, but extremely costly approaches to Phase 3 monitoring.

The Sarbanes-Oxley Program (S.O.P.), as discussed below, constructed in accordance with the invention addresses all three phases of the S.O.A. requirements. It provides a very cost-efficient solution to each of the three phases, including the on-going monitoring requirement. Phase 3 monitoring is a natural extension to the work completed in Phases 1 and 2. Most importantly, S.O.P. can be seamlessly implemented at whichever phase the company elects to do so.

The Sarbanes-Oxley Act became law on Jul. 30, 2002. Section 302 of the law compels executives to understand and prioritize transactions according to their material impact on the company's financial statements. Management must maintain documentation of:
Basic and critical business processes;
Transaction discipline; and
Related internal controls.
   Section 404 drives companies to understand and document the details of its operations (i.e. the business process), the reporting of its results, and to assign responsibility, ownership and accountability for its reporting of financial conditions. The company must file an internal control report with its annual 10K report including:
Management's responsibilities to establish and maintain internal controls; and
Management's conclusion on the effectiveness of these controls.
   Therefore, the SEC requires organizations to establish a sound internal control structure while managing and monitoring that structure proactively and on an on-going basis.

The Sarbanes-Oxley Program, which was developed to address management's responsibilities vis-à-vis Sarbanes-Oxley, is based upon the concept of visualized and documented business processes. This methodology is designed so that management can attest to the source and accuracy of its financial statements.

A business process mapping methodology and supporting software has been previously developed to provide the visibility management requires to monitor objectives effectively. This business process mapping methodology was previously patented by one of the inventors here as U.S. Pat. No. 5,321,610. It is used by Fortune 1000 companies here and abroad in a variety of applications.

The business process mapping methodology is marketed by large software developers (e.g. Computer Associates and MAPICS) to streamline the implementation of their large application software systems. It is also used to achieve ISO 9000 certification and FDA validation, and for re-engineering and business continuity planning. The common thread in these applications is the requirement and inherent advantage of defining and managing business processes.

To deal with the problems caused by the passage of the S.O.A. it is necessary to have a program and a system to guide companies in obtaining and maintaining compliance with the Sarbanes-Oxley Act—the Sarbanes-Oxley Program (S.O.P.)—drawing upon the concept of standard operating procedures commonly called s.o.p.'s. The program and the system is described below.

### The Sarbanes-Oxley Program (S.O.P.)

Overview

The S.O.P. system includes a repository of best practices that incorporates audit and control point icons linking to the appropriate audit procedures. This repository can be modified to reflect actual company processes, actual audit points, and actual audit procedures. Relevant spreadsheets and enterprise resource planning (ERP) procedures on how to perform the detail audits are provided for each control point (i.e. work papers). Business activity monitors alert the audit committee of potential problems. These monitors are customized for each S.O.P. customer in the deployment phase. The Sarbanes-Oxley Program enables users to:
View the critical financial processes (e.g. accounts payable, accounts receivable, procurement, etc.) from a management perspective;
Customize and revise the views to tailor them to business practices that are unique in their company, and to the changes that occur in their business;
Build Sarbanes-Oxley compliance into a company's infrastructure; and
Drill down to every critical reporting site in a company to monitor and ensure the attestation process is taking place.
Bubble up alerts to management and senior management when any required activities are not performed or deadlines are missed.

How is this accomplished?

S.O.P. identifies one hundred and twenty-nine financial control objectives in a typical company. This is accomplished by first identifying common business cycles or, as it is considered, best practice business processes. Then those objectives are applied to over two hundred internal control points developed by the Committee of Sponsoring Organizations (COSO), to provide the guidelines against which management may evaluate and report on the effectiveness of the company's internal control. Management can easily expand the one hundred and twenty-nine objectives with additional control activities and related documents as appropriate to their organization's needs.

S.O.P. uniquely integrates COSO guidelines to specific company operations, thereby providing the VISIBILITY necessary for management. Each control point includes:
The associated risks;
The COSO-compliant audit procedure that must be executed;
The work papers; and
The audit history of events, results and actual dates of compliance audits.

This integration and access to support documents are available 24/7 to management and to a company's audit committee. In addition to the information's being accessible to management, the S.O.P. pushes relevant notices up the corporate management structure to assure timely compliance activity or awareness of failures.

Documentation

S.O.P. provides visual Documentation of a company's business processes and its applicable audit control points. Uniquely, each COSO-compliant control point is linked through S.O.P. with related identifiable risks, audit procedures, work papers and audit compliance history. Critical to the working of S.O.P. is the way financial in which theses elements are linked through business work flows, financial processes and job hierarchies.

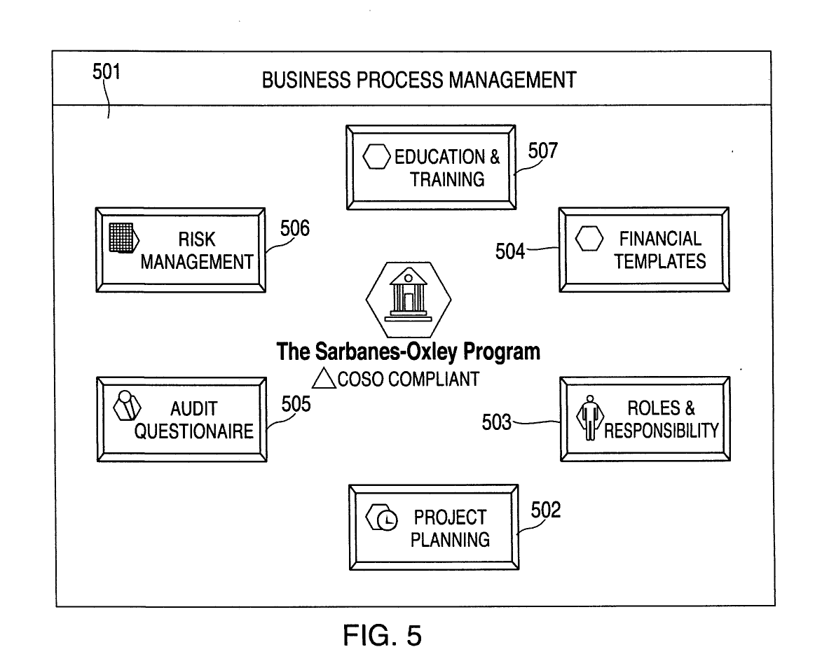

The Sarbanes-Oxley Program, therefore, is a repository of financial processes, COSO-compliant procedures, work papers, and historical record of control audits. FIGS. 5-10 as described in more detail below include actual S.O.P. screens or views. S.O.P. defines business processes in material activities and clearly defines which ones require management controls.

The best practices template is displayed with the applicable control activity point. This, in turn, defines the inherent risk, the COSO objective, and logs the activities to be taken. The activities are maintained in an audit compliance database for management to test the internal controls and provide proof of compliance. This documentation and visibility, therefore, provides the tools to management to EVALUATE its financial controls. It does so by identifying the control points, reviewing the activities and accessing the work papers.

The Result

S.O.P. provides many benefits to management. In addition to proving compliance, these benefits include cost-effectiveness, portability, and timely compliance.

Cost-Effectiveness

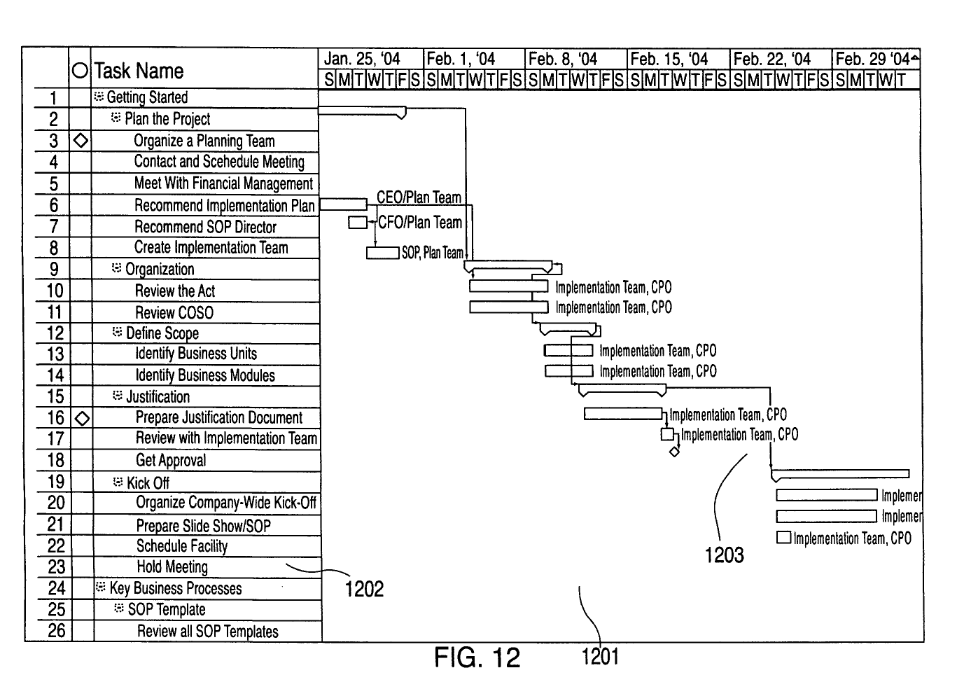

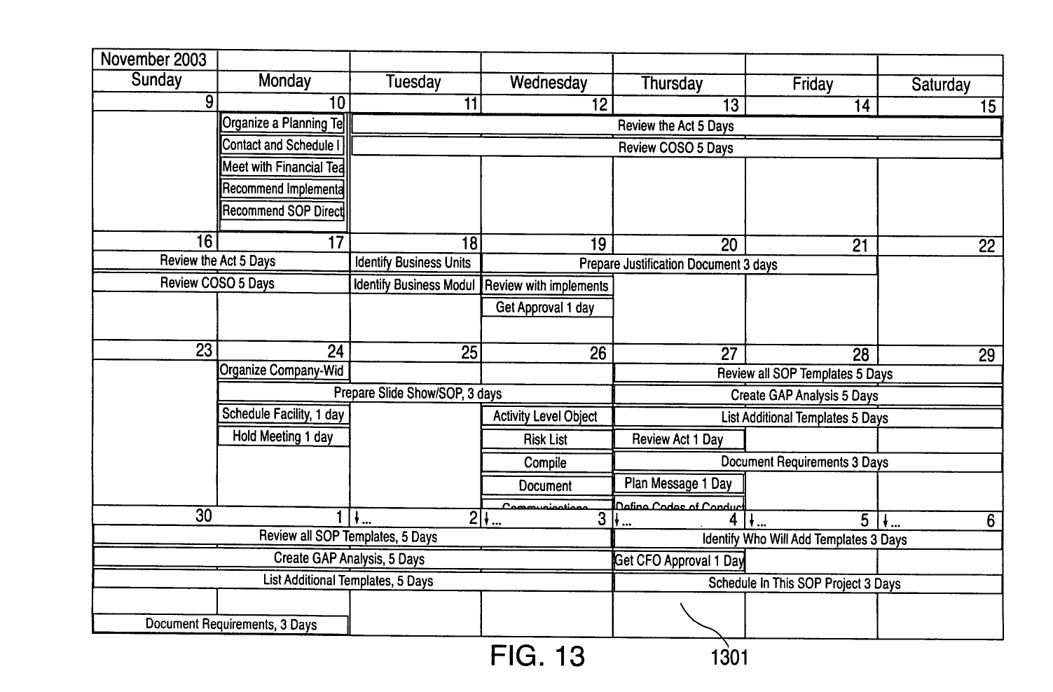

S.O.P. includes a detailed plan in Microsoft Project™ to identify all tasks necessary to implement Sarbanes-Oxley. FIGS. 12 and 13 illustrate the type of integrated S.O.P. plan elements accessible from the S.O.P. portal. This plan clearly identifies the applicable business processes as well as the one hundred and twenty-nine COSO-recommended financial control objectives and any additional ones added during installation.

S.O.P. relieves project managers of the costly process of (1) selecting business processes; (2) documenting those processes; (3) defining one hundred and twenty-nine control objectives and where they should be implemented; (4) writing audit procedures; and finally (5) setting up a data base of risks, history and work papers that is essential for evaluating controls in a cost-effective manner.

S.O.P. also includes a training and educational component designed to ensure that employee have the training and education they need to perform their duties in operations and auditing for control. The curriculum includes:
Understanding the Sarbanes-Oxley Act requirements;
Understanding the COSO Standards;
Understanding a company's Audit Requirements.

The history of each employee's training is maintained, and test scores also may be accumulated. Each employee in S.O.P. has a job description and links to his/her role, responsibilities, and assigned financial business process. The company's Audit Requirements is a feature that is customized during the deployment phase as the company refines the S.O.P. to its installation.

Portability

S.O.P. is a site-specific financial business process repository. It is the corporate standard. It can be implemented on the intranet and/or internet for company-wide guidance. It can be accessed and customized by each division and subsidiary quickly and cost-effectively. Without this company repository, companies may attempt to recreate the process at each site at considerable (and unnecessary) time and cost.

Timely Compliance

The Sarbanes-Oxley Act is to be implemented immediately, with the exact date dependent upon the company's size and fiscal year-end. When management detects a deficiency that is deemed to be material, corrective actions and controls must have been in place and operating for a sufficient period of time prior to the date when management asserts that the controls are adequate. It is imperative, therefore, that the controls be in place as soon as possible. S.O.P. is designed to that end. Actual audits may begin immediately.

### Summary—The Framework to Communicate

Under the Sarbanes-Oxley Act, initially, executives will have to testify that their companies have adequate internal controls to prevent and detect accounting violations and fraud. Secondly, the accounting firm that audits a company's books will have to attest in the annual report that company officials consider the internal control over financial reporting to be adequate. Thirdly, at the end of each quarter, company management will have to evaluate and report any substantial change in internal financial controls.

The Sarbanes-Oxley Program (S.O.P.) uniquely satisfies these three key requirements. S.O.P. is a Sarbanes-Oxley template that is COSO-compliant. All current processes requiring audit are presented graphically as best practice models with audit points clearly defined. The model is a repository of business processes and audit points. Each audit point addresses the one hundred and twenty-nine COSO objectives involved, the audit procedure utilized, and accesses all resulting audit work papers, spreadsheets, and observations. The business activity monitoring facility allows users to identify potential audit trouble indicators, and automatically alert the audit committee of pending or actual problems.

Requirements other than those contained in Sections 302 and 402 of the Sarbanes-Oxley Act are addressed in the Audit Checklist, which is included in S.O.P. Requirements for audit independence, for example, are included in this program. COBIT, the requirement for the IT function (Information Technology), is also inherent in S.O.P. S.O.P. provides the visibility, portability and timeliness to allow management to assert its assurance of adequate financial controls. It is designed to assist the audit committee to perform its increased responsibilities relating to attesting to the adequacy of financial controls.

S.O.P. is COSO-directed and, if followed, should reduce management's vulnerability in asserting compliance. It should also become management's framework to communicate its intentions to improve controls, and, in the end, to improve the company. That commitment is extremely important to the new members of the company itself, and to the financial community at large.

The Sarbanes-Oxley Program—Screens and Concepts

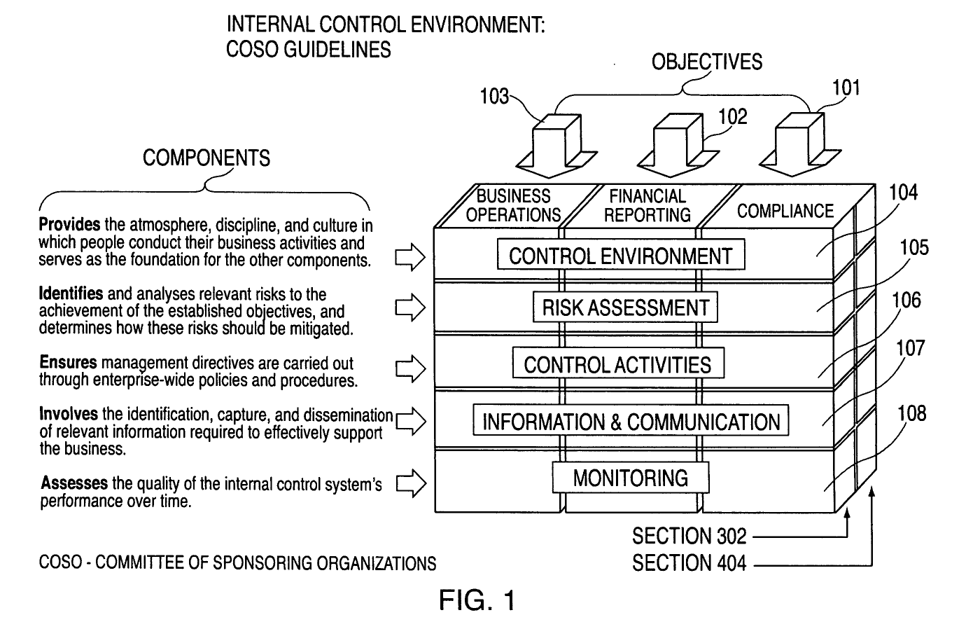

S.O.P. includes specific financial models (or templates) reflecting actual business processes including general ledger, accounts payable and accounts receivable as well as normal business processes affecting financial reporting including revenues, shipping and manufacturing expenses. These templates reflect the transactions that must be audited to comply with sections 404 and 302 of the Sarbanes-Oxley Act. See FIGS. 1-3 which show the structure and elements involved under the Sarbanes-Oxley Act.

Reference is made to FIG. 1 wherein the internal control environment under the COSO guidelines incorporated into the Sarbanes-Oxley program is depicted. Objectives 101-103, which are Compliance, Financial Reporting and Business Operations, are shown as the vertical columns in the block of FIG. 1 and each of the columns is made up of a Control Environment 104, Risk Assessment 105, Control Activities 106, Information & Communication 107 and Monitoring 108. The Control Environment 104 provides the atmosphere, discipline and culture in which people conduct their business activities and serves as the foundation for the other components. Risk Assessment 105 identifies and analyzes relevant risks to the achievement of the established objectives, and determines how these risks should be mitigated. Control Activities 106 ensures management directives are carried out throughout enterprise-wide policies and procedures. Information & Communication 107 involves the identification, capture, and dissemination of relevant information required to effectively support the business. Finally, Monitoring 108 assesses the quality of the internal control system's performance over time. The arrows from the marked Sections 302 and 404 relate to different sections under the Sarbanes-Oxley Act, which are implicated in connection with the compliance objective. These guidelines have been established by COSO, which is the committee of sponsoring organizations.

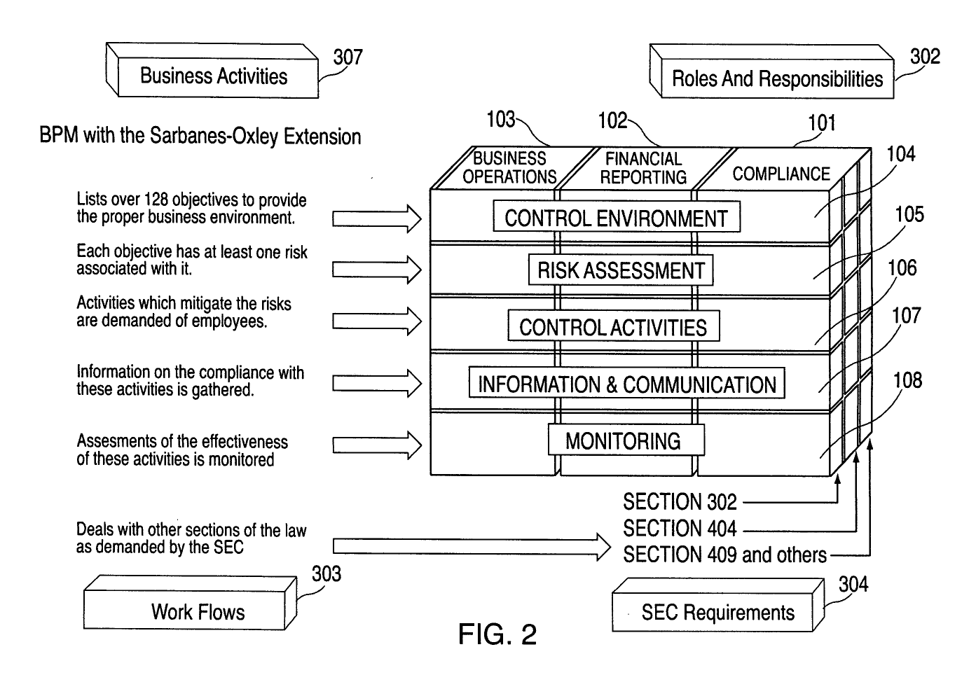

Reference is next made to FIG. 2 wherein a similar drawing is shown, like elements being represented by like referenced numerals. The major difference in the block of FIG. 2 from FIG. 1 is the addition of a third level of Compliance related to sections 409 of the Sarbanes-Oxley Act and others, as well as the interfacing with the Roles and Responsibilities 302, Work Flows 303, Business Activities 301 and SEC Requirements 304. The S.O.P. includes in the Control Environment 104 a listing of over 128 objectives to provide the proper business environment. It includes in Risk Assessment 105 each objective's having at least one risk associated with it. In Control Activities 106 the activities which mitigate the risks are demanded of employees. Information & Communication 107 includes communication on the compliance with these activities being gathered. In Monitoring 108 there are assessments of the effectiveness of these activities to be conducted being monitored. Finally, the S.O.P. deals with other sections of the law as demanded by the SEC under sections 409 of the Sarbanes-Oxley Act and others. Each of these components fit together in a way which allows for the objectives of Compliance 101, Financial Reporting 102 and Business Operations 103 to be implemented and supported.

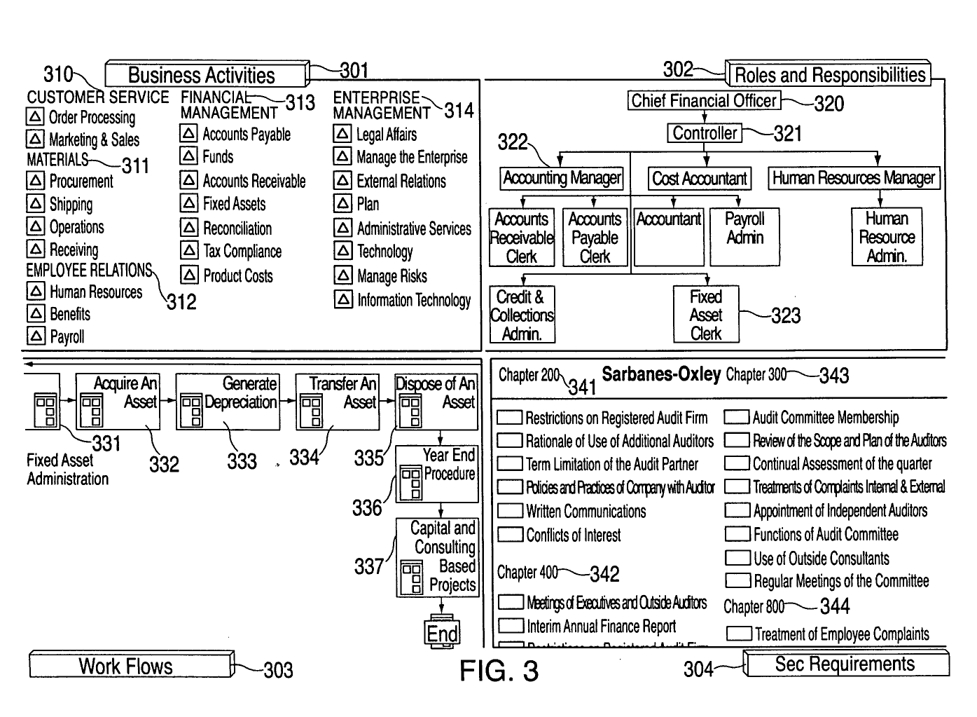

Reference is made to FIG. 3 which shows four separate screen shots corresponding to Business Activities 301, Roles and Responsibilities 302, Work Flows 303 and SEC Requirements 304.

With reference to the screen shot relating to Business Activities 301 the business activities are divided down into Customer Service 310, Materials 311, Employee Relations 312, Financial Management 313 and Enterprise Management 314. Each of these separate categories has several icons under each of them. For example, Financial Management 313 has seven icons associated with it, the fourth of which is Fixed Assets.

The screen shot of FIG. 3 relating to Roles and Responsibilities 302 includes an organization chart showing the Chief Financial Officer 320 at the top with a Controller 321 reporting to him. In turn, an Accounting Manager 322 reports to the Controller 321 and a Fixed Asset Clerk 323, in turn, reports to the Accounting Manager 322. Other organizational charts of various sorts can be included, but the S.O.P. functionality is designed to show organizational charts with both the Chief Financial Officer 320 and a Chief Executive Officer at the tops of charts due to their obligations under the Sarbanes-Oxley Act. Access to specific activities, control points and audit compliance screens is accessible through the organizational charts approached by clicking on a job title.

The lower left screen shot related to Work Flows 303 shows the different procedures associated with a fixed asset administrator which, in most cases, would be Fixed Asset Clerk 323. In this case the procedures include Acquire an Asset 332, Generate Depreciation 333, Transfer an Asset 334, Dispose of an Asset 335, Year End Procedure 336 and Capital and Consulting Based Projects 337. By clicking one of these procedures, one could determine the actual process steps to be performed, as well as the compliance control and appropriate financial reporting elements associated therewith.

Finally, the screen shot on the lower right of FIG. 3 related to SEC Requirements 304 includes requirements tied to various chapters of the Sarbanes-Oxley Act, including Chapter 200 related activities 341, Chapter 300 related activities 343, Chapter 400 related activities 342 and Chapter 800 related activities 344. For example, the Chapter 200 related activities 341 include Restrictions on Registered Audit Filings, Rationale of Use of Additional Auditors, Term Limitation of the Audit Partner, Policies and Practices of Company with Auditor, Written Communications and Conflicts of Interest. Each of these is dealt with in an appropriate fashion through the S.O.P.

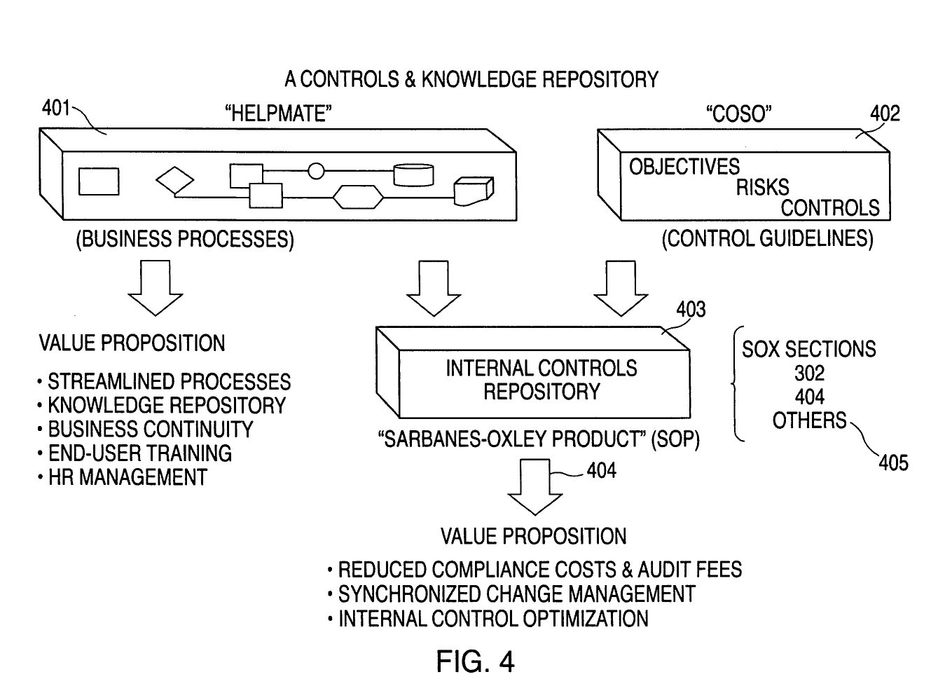

Reference is next made to FIG. 4 in which the generalized organizational structure of the S.O.P. is identified. A “Helpmate” Business Processes package 401 and the COSO Control Guidelines including Objectives, Risks and Controls 402 input into an Internal Controls Repository 403, which is the Sarbanes-Oxley product 403. The Internal Controls Repository 403 also receives input from the Sarbanes-Oxley sections 302, 404 and the other relevant sections. The effect of that is to produce a Value Proposition 404 which includes Reduced Compliance Costs & Audit Fees, Synchronized Change Management and Internal Control Optimization. The Helpmate system 401 is the business processes system and includes the business process mapping methodology previously patented under U.S. Pat. No. 5,321,610.

The operations and financial templates are populated with objectives, risks, and control activities as defined in the COSO standards adopted by the Act. Therefore, the cost and labor intensive requirements of compiling with Sarbanes-Oxley sections 404 and 302 are mitigated by S.O.P. It is as simple as the fact that starting from scratch with a blank piece of paper is an expensive alternative.

S.O.P. is comprised of a process-mapping tool and a methodology which work together to create and maintain knowledge repositories including the S.O.P. audit templates. The tools and methodology allow users to model all of their daily (or emergency) operations, to easily modify them as circumstances require, and to provide a clear graphical representation of business practices that can be viewed from many different perspectives. It can be integrated with any ERP or financial software system. S.O.P. can be configures as a standalone, client/server or web-based system. The ability to get at the same information from a number of different perspectives and entry approaches is an important element of the increased value provided by the S.O.P. system. For example, the same business processes can be reached either by way of the business functions, an employee's responsibilities or through the documentation.

S.O.P. comes with these important features and functions:

1. Complete set of financial process maps

2. Integration of process maps with any ERP application

3. Sarbanes-Oxley audit templates

Sarbanes-Oxley templates include control points with:
Associated objectives and risks
COSO-compliant audit control procedures/activities
Audit results and dates of audit activity
Notification of failed or missed audits

FIG. 5 illustrates S.O.P. functionality. S.O.P can easily be modified to accurately reflect any company's actual workings. Reference is next made to FIG. 5 wherein a screen shot of the Business Process Management module of the Sarbanes-Oxley program in accordance with a preferred embodiment of the invention 501 is depicted. Screen shot 501 of this highest level screen shows a series of icons, including Project Planning 502, Roles and Responsibility 503, Financial Templates 504, Audit Questionnaire 505, Risk Management 506 and Education and Training 507. Project Planning 502 is a detailed plan (over 100 tasks) of how to implement Sarbanes-Oxley using the S.O.P. methodology. Roles and Responsibility 503 identifies actual employees and their roles and responsibilities in compliance with the Act. Financial Templates 504 leads to over 100 financial operations and templates which define the process and identify specific COSO directed audit control points as specified in Sections 404 and 302 of the Act. Audit Questionnaire 505 includes audit attestation for all sections of the Sarbanes-Oxley Act other than sections 302 and 404 such as the requirements in sections 201, 301 and 409. Risk Management 506 provides users and audit committee members with direct access to 200 plus risks organized by business activities such as customer service, financial management, etc. Education and Training 507 is a training module for employees with recorded results including courses in Sarbanes-Oxley, COSO and audit requirements. IT Supervision (not shown) provides the IT department with the standards it must establish to comply with the Act. The results here, as elsewhere in S.O.P. are maintained in an S.O.A. repository of audit activities and results.

The Sarbanes-Oxley Program uses the concept of business process mapping to achieve compliance by approaching potential problems from three different directions and offering solutions to each of the COSO identified risks. The potential problems may be approached by business process, COSO risk category or by employee roles and responsibilities.

COSO is the standard for control points which should be checked or audited periodically.

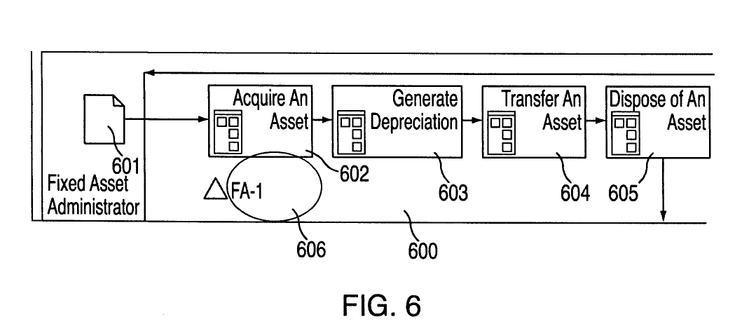

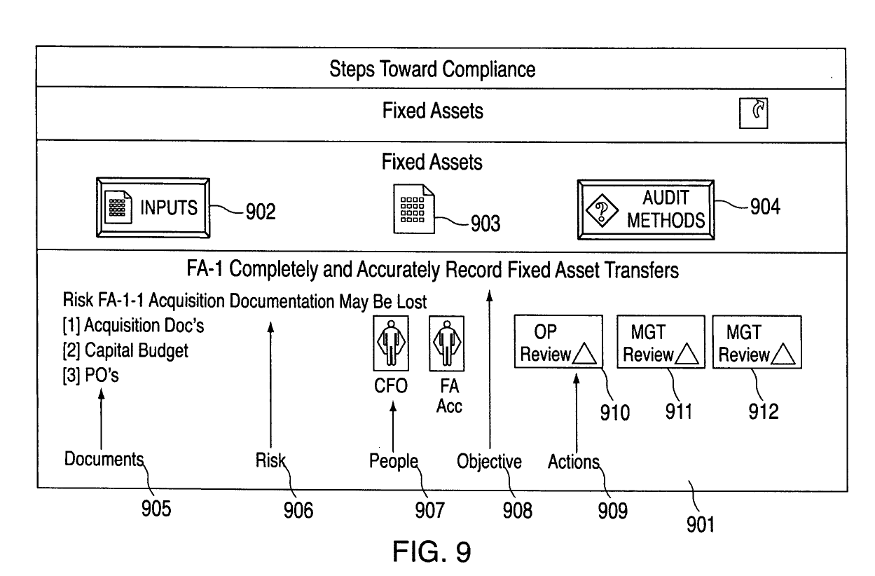

Reference is next made to FIG. 6 wherein a screen shot 600 showing Fixed Assets as an example is depicted. The Fixed Asset Administrator 601 is responsible for processes relating to Acquiring an Asset 602, Generating Depreciation 603, Transferring an Asset 604 and Disposing of an Asset 605. The highlighting 606 on Acquiring an Asset will take one in the program to the screen of FIG. 9.

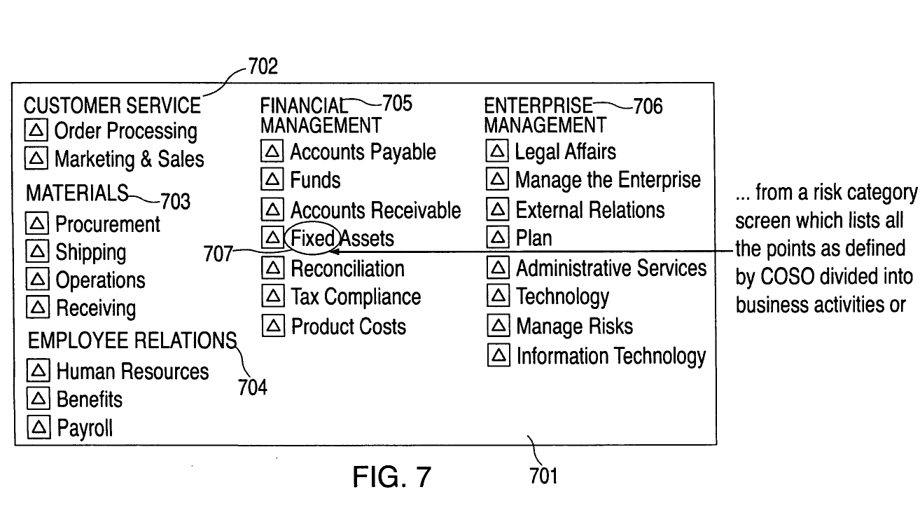

Similarly, in FIG. 7, which lists all the control points defined by COSO into business activities, screen shot 701 shows the different categories including Customer Service 702, Materials 703, Employee Relations 704, Financial Management 705 and Enterprise Management 706. The highlighting 707 shows the box which, if clicked on, would, again, lead to screen 9.

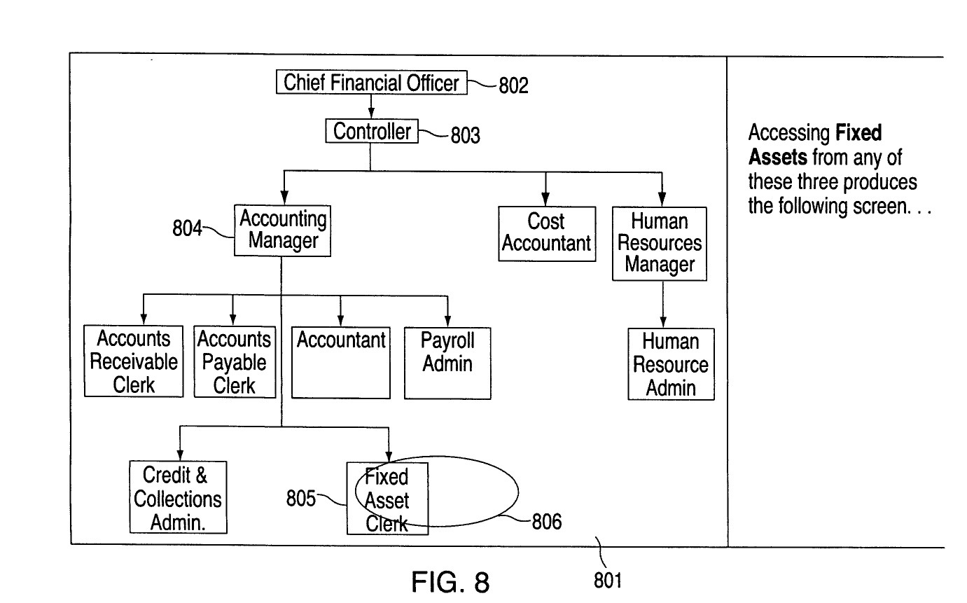

Finally, reference is made to FIG. 8 wherein a job structure chart screen shot 801 is shown headed by Chief Financial Officer 802, with Controller 803, Accounting Manager 804 and Fixed Asset Clerk 805. Again, by clicking on the highlighting 806 on Fixed Asset Clekr 805 one would be taken to the screen shown in FIG. 9. Thus, the strength of the system is that one can reach the same Fixed Asset screen, or any such screen which lists the objectives, risks, documents and people involved and actions which should be taken to mitigate the risk of noncompliance either through a business process access route, a risk category approach or a job structure approach.

With reference to FIG. 9, the screen shot 901 includes clickable icons for Inputs 902, Fixed Assets 903, Audit Methods 904, as well as identifying the Documents 905, the Risk 906, the People involved 907, the Objective 908, the Actions 909, which include OP Review 910, And Management Reviews 911, 912.

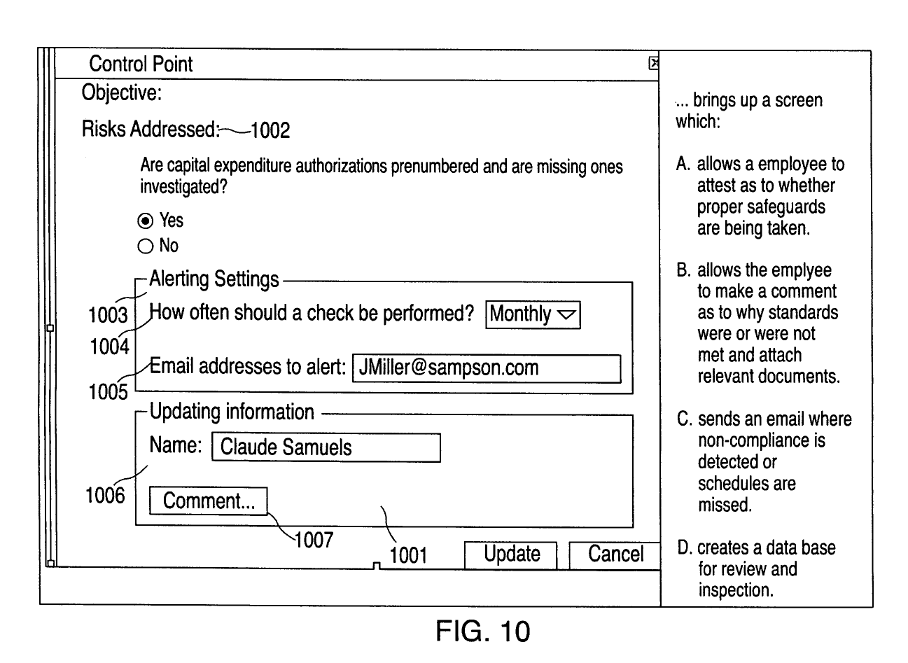

Clicking on the OP Review button 910 brings one to FIG. 10, which is a screen shot 1001 which includes the Risks Addressed 1002, Alerting Settings 1003, frequency of checking 1004, Email addresses to alert 1005, Updating Information 1006. This allows an employee to attest as to whether the proper safeguards are being taken. It allows the employee to make a comment as to why standards were or were not met and attach relevant documents by clicking Comment button 1007. The system automatically sends an email when noncompliance is detected or schedules are missed. In addition, it creates a database of such evidence of such noncompliance or missed schedules which is both available for review and inspection up the job chain up to the CFO or CEO as appropriate and which is pushed by the system to the appropriate managers to follow up and achieve compliance.

The Sarbanes-Oxley module allows users to check these points from standard process flows as shown above or from a risk category screen which lists all the points as defined by COSO divided into business activities (FIG. 7) or by the Job structure chart (FIG. 8), accesssing Fixed Assets from any of these three produces the screen shown in FIG. 9 which lists the Objectives, Risks, Documents and People Involved, and Actions which should be taken to mitigate the risk of non-compliance. Clicking on the first action button brings up a screen (FIG. 10) which:
A. allows a employee to attest as to whether proper safeguards are being taken.
B. allows the employee to make a comment as to why standards were or were not met and attach relevant documents.
C. sends an email when non-compliance is detected or schedules are missed.creates a data base for review and inspection.

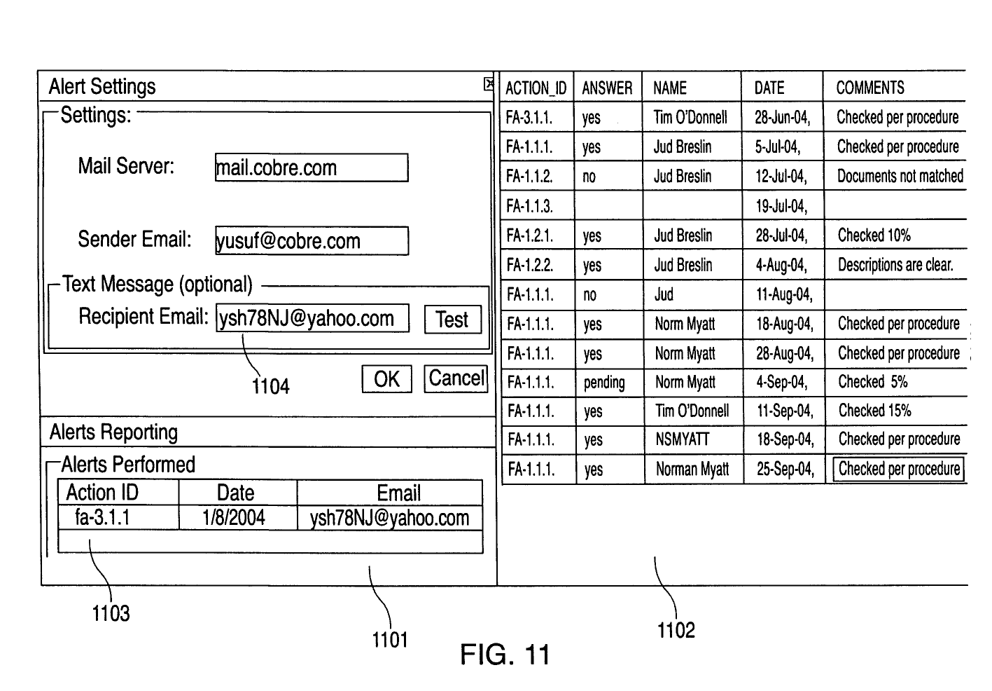

The constant demand for and review of compliance data is an invaluable tool, which will make subsequent reviews in the years to come much, much easier and less time-consuming. As shown in FIG. 11, alert settings and alert reporting screens open up to a detailed screen which identifies activities which must be taken and alerts which must be reviewed. FIG. 11 represents three separate screens which are collected together in on figure.

Reference is made to FIG. 11 wherein a screen shot 1101 which, in turn, is made up of three separate screens together, Alert Settings screen 1104, Alerts Reporting screen 1103 and Detailed Reporting screen 1102.

In addition to the above elements a time line for implementation with each of the Timetables, Resource tables, Calendars involved in each step also integrated into the S.O.P. system for planning, management and control of the process. A sample portion of this is shown in FIG. 12, and in a different format in FIG. 13.

Reference is made to FIG. 12 wherein a screen shot 1201 of a timeline for implementation including the Time Tables, Resources Tables and Calendars involved in each step are integrated into the system for planning management and control of the process. The screen shot 1201 includes a Task portion 1202 and a Calendar portion 1203 in accordance with traditional time management software programs.

Reference is next made to FIG. 13 which provides a similar functionality in screen shot 1301 except oriented in a more traditional calendar format identifying planning activities and also identifying the time allocated for each of the activities.

The software constructed in accordance with a preferred embodiment of the invention for Sarbanes-Oxley compliance includes at least five key points. First, it is cost effective because it starts with about 85% to 90% of the content in a repository where it can be easily accessed in the installation process. Second, the attestation portions of the software support broad detection in three phases: design, operation and remediation. Third, only a single entry need be made into the system and all the information in the database is accessible throughout the system as appropriate. Fourth, there is easy reporting available for CEO's and CFO's. The CEO's and CFO's are able to comply with the Sarbanes-Oxley requirements with confidence. Much in the same way that in technical areas such as the chemical industry, when technology is available to prevent accidents and a company does not use it, they are liable for being negligent, the software constructed in accordance with a preferred embodiment of the invention provides an enhanced degree of protection and control which makes those entities not utilizing the software more likely to be subject to liability for failure to meet the Sarbanes-Oxley goals. Fifth, the system comes with over 700 controls pre-built in with easy availability to add, delete or modify the controlled section during the design and installation phase of using the system.

Screens in the Sarbanes-Oxley program are built by level. Each level has a look and feel set by the administrator. When the administrator is setting up and enabling the system a style is established for each level so that there is additional clarity. The different levels add clarity because there may be hundreds of screens which need organization and the different levels in the hierarchy provide a way to organize and find one's way among the different screens. The icons are added to the screens, again, at the administrator's control, which may be customized from the program. The icons are set up as drag-and-drop icons which can be added and changed relatively easily. Generally, the screens are built by developers. The look and feel is established by the administrator in consultation with the users to provide the most reliable and easy accessibility within an organization.

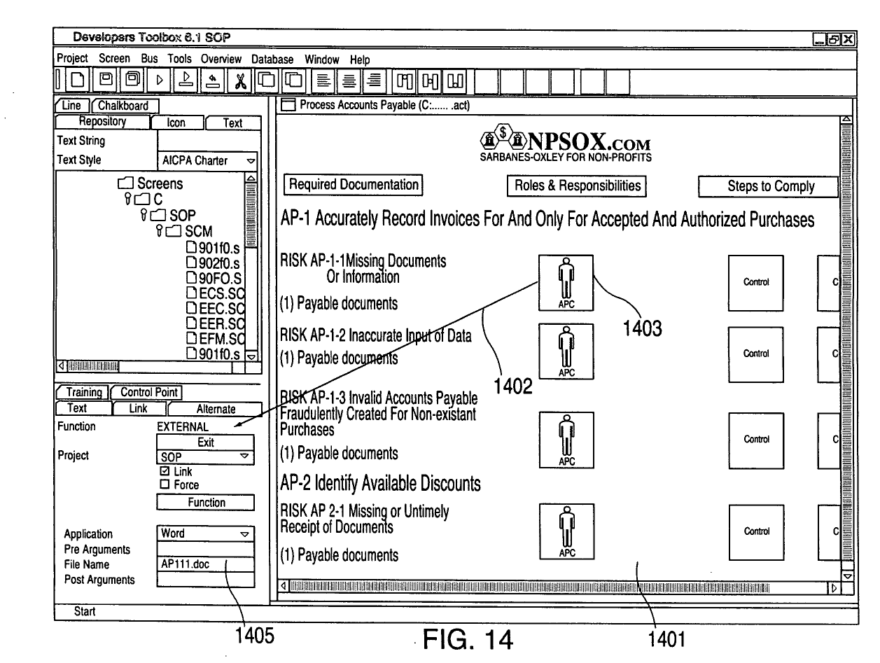

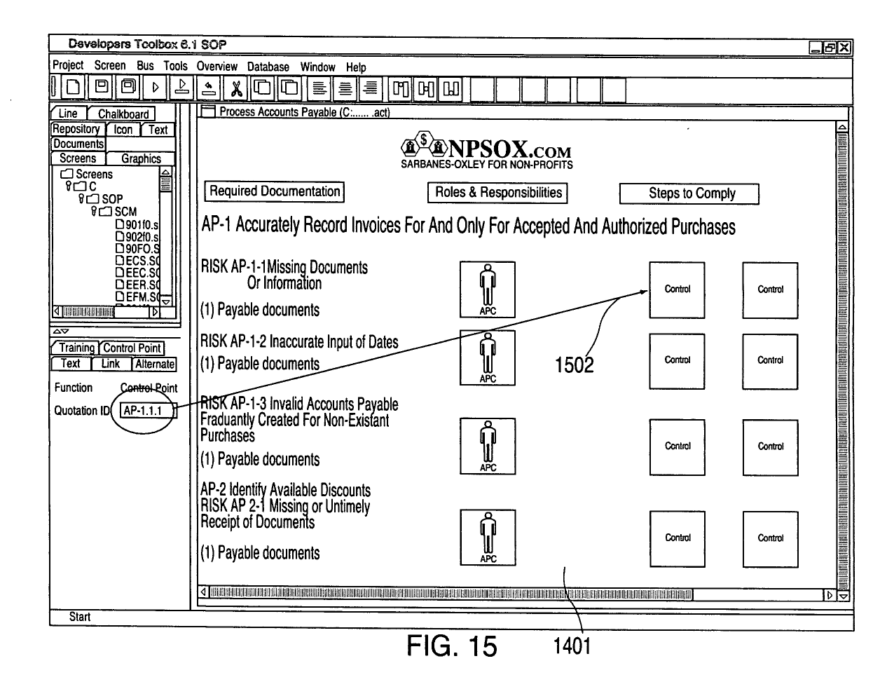

Reference is made to FIG. 14, which is a screen shot 1401 showing the way in which the screens are linked through icons and links are added. The administrator would set the identity of the icons. In the case shown with the arrow 1402 included being added for purposes of explication only and which is not a part of the actual screen shot, the icon 1403 shown at the top as highlighted would be linked to the Word document shown in box 1405 at the lower left. The icons have an identity set by the administrator. For example, an icon could be a functionality icon linking to a functionality screen. As shown in FIG. 15, the same screen 1401 is shown which identifies in the developer's toolbox, used to set up the S.O.P., a process accounts payable screen, which identifies in three columns, required documentation, associated roles and responsibilities and the steps to comply. For each of the risks there is a document or documents shown and then the appropriate individual in the middle column, in this case, APC, which corresponds to the Accounts Payable Clerk, and the control steps to be followed to comply with the roles and responsibilities with respect to the risks. The box at the lower left connected by the arrow 1502 drawn on FIG. 15, which is not a portion of the screen shot, shows that a link is established to a control point as shown circled and connected with the arrow added to the screen shot of FIG. 15. The control point in this case is AP-1.1.1. The control identifier is entered to complete the links so that when a user clicks on the identified control icon, they would be shifted to the appropriate control point.

In analyzing the S.O.P. system it is useful to look at the methodology in two ways, first, defining responsibility within the implementing organization and second, attestation. The first, defining responsibility within the claim includes process oriented and financial statement oriented matters and cross-referencing between the two.

In the process oriented matters one starts with a generic template with the process owners selecting key processes and within the organization there is a confirmation of the accuracy of the “ways of working”. Next the legislative (SOA) directives are reviewed, which includes the COSO and COBIT directives discussed above. Next the SOA directives are pointed to the relevant business processes in accordance with COSO and COBIT and verification and approval is obtained by the auditing authority (management). Responsibility is then assigned and the legal implications confirmed by the appropriate in-house and outside professionals and management. Finally, responsibility sign-offs are obtained.

For the financial statement oriented matters a similar sequence is involved. First, one starts with the five critical reports that must be sent to the Securities and Exchange Commission. Each line item is analyzed to see what is the chart of account and are there calculations, which need to be incorporated. These results must be confirmed with the Chief Financial Officer (CFO). Next the SOA requirements are reviewed and the SOA directives are pointed to line items in accordance with COSO/COBIT. The steps to this point are verified and approved with the auditing authority and finally responsibilities are assigned to suppliers of information to the General Ledger and to confirm legal implications.

Next the process-oriented and financial statement oriented efforts must be cross referenced. From the SOA directives the processes and statements are correlated. The responsibilities are correlated. The sign offs are correlated such that the appropriate person is resolved to assure that he/she is responsible for a particular process and understands it will update the general ledger and become instrumental in the final statement of the company. Finally all of the audit control points are linked to the core ERP/Financial Systems products in use in the company.

The attestation methodology includes four areas: automated; Section 404 and 302 matters; other non-ERP areas by methodology; and visibility is available to the Audit committee. In the automated area each control activity is recorded by each methodology. Each control activity requires responsibility by each methodology. Notification of result of the audit is automatic/methodology whether as a result of failure or a missed schedule. Business activity monitors automatically and flags non-conforming activities.

The Section 404 and 302 activities provides that control activities are assigned and results are recorded. Failures are updated automatically. Management is advised of any failures.

In the other non-ERP areas by methodology, each are audited in exactly the same automated fashion in accordance with the established audit controls. There is a general corporate commitment (ethical commitment). There is also an allocation of information technology (COBIT) responsibility.

In the screen 1401 shown in FIGS. 14 and 15 the control panel provides for attestation that is captured in the database. Attestation is very important for fraud detection. The first attestation is to the design, the second attestation is to the operation and the third attestation is to remediate, if required. There are email alerts for upcoming tests, failed tests and late tests. The first attestation is a design effectiveness panel control that an appropriate individual has certified that the control has been effectively designed. That information is retained in the repository database. The second attestation that the control is operating effectively is similarly certified by an appropriate individual with information going into the database as to whether or not the testing has passed or failed, who attested to the control in operation, as well as the assessment area, test start date, email address of the tester, frequency of testing, its importance, to whom the test was assigned, and the location for any post email alerts. In the event that the test fails, then remediation is required and tracked through a third attestation which is assigned to an appropriate individual. The remediation plan is attached and a completion date and retest date are entered. Finally, reports are generated for the CEO and CFO so they can have confidence that the controls are in place and are working. The CEO must certify the status of the controls in accordance with the acts. The online real time reports on hundreds, if not thousands, of control records is critical to the CEO's comfort and ability to reasonably certify the status of the controls.

The system in operation allows one to enter the repository through three lines. Either through internal controls which are the COSO activities, Roles and Responsibilities which are the descriptions of the responsibilities by job title and through the methodology which provides links to the plan.

In connection with the visibility available to the audit committee, there is a development of how to audit, the proof of the audit and the framework to communicate.

In addition to the methodologies described above, there is a detailed system of internal controls. The business process models include a series of templates which include all standard business processes which can be added to or deleted as inappropriate to the needs of the specific industry and company. The control actions, selected from the over 500 established from COSO-COBIT are again reviewed against the companies work flows and activities with appropriate additions, deletions or changes. Next the business process models and the control actions are married so that they can be accessed for either top/down or bottom/up organizations. The business process models are linked to allow connection both ways with the control actions and rules. Other documents are linked from the control actions and the roles. Alerts are added for the control actions to allow monitoring. A control action database is created to include information and communication.

Accordingly an improved system for implementing and maintaining a control system for compliance with the requirements of the Sarbanes-Oxley Act is provided.

It will thus be seen that the objects set forth above, among those made apparent in the preceding description, are efficiently obtained and, since certain changes may be made in the above constructions without departing from the spirit and scope of the invention, it is intended that all matter contained in the above description or shown in the accompanying drawings shall be interpreted as illustrative, and not in a limiting sense.

It is also understood that the following claims are intended to cover all of the generic and specific features of the invention herein described and all statements of the scope of the invention, which, as a matter of language might be said to fall therebetween.

What is claimed is:

1. A system for providing compliance and maintenance of process control, comprising:
a database of business processes used by an enterprise;
a database of employee positions and responsibilities;
a database of audit control points;
means for linking the databases to provide linking among the three databases and to enable control of each of the audit control points accessible from either the business processes or employee data bases; and
means for notifying appropriate employees of control activities required.
